(19) United States
(12) Patent Application Publication
(10) Pub. No.: US 2011/0207503 A1
(43) Pub. Date: Aug. 25, 2011

(54) FACILITATING ASSISTED GPS AND OTHER NETWORK SERVICES IN MOBILE PHONES ACROSS DISPARATE MOBILE COMMUNICATIONS NETWORKS

(76) Inventor: Netzer A. Ruperto, Bonita, CA (US)

(21) Appl. No.: 12/709,202

(22) Filed: Feb. 19, 2010

(51) Int. Cl. H04M 1/00

(52) U.S. Cl. 455/552.1

(57) ABSTRACT

The present invention provides a mobile device that is able to implement A-GPS and other network services across multiple disparate communications networks In an exemplary embodiment of the invention, a mobile communications device implements a plurality of mobile network profiles—each profile being associated with a different mobile network and its respective carrier, i.e., operator or service provider. Each profile comprises multiple data parameters that are used to authenticate a valid mobile device to the respective communications network carrier and for opening a data channel such as a transmission control protocol and internet protocol (TCP/IP) data connection. These data parameters are used to facilitate communications with a remote server on the network such as a server for performing A-GPS. As soon as the mobile device detects that no signals can be received by the current active mobile network operator, it will assess other stored mobile profiles and determine if it can receive signals from one of the other available mobile networks signals being received, and if so it will load and activate a new mobile profile to authenticate the device for use with the visiting mobile network.

### BACKGROUND OF THE INVENTION

1. Field of Invention

This invention relates to location tracking of mobile devices and more specifically, to a technique for improving the handling of location tracking and other services in mobile devices roaming across disparate mobile communications networks.

2. Description of Related Art

The Global Positioning System (GPS) is a satellite based global navigation satellite system that enables suitably equipped receivers on the Earth to gain accurate location information. GPS employs a total of 24 active satellites that have been placed in six different equally spaced orbital planes with four satellites in each. Generally, this satellite configuration provides the earth receiver with a view, i.e., signal reception, of between five and eight satellites at any time from any point on the Earth. The satellites transmit synchronized signals that are received and used by the receivers to deduce their position, e.g., latitude, longitude, and altitude. GPS provides reliable positioning, navigation, and timing services to worldwide users on a continuous basis anywhere on or near the Earth. Numerous location based services and location tracking applications have been adopted with the widespread commercial availability of GPS receivers and chipsets implemented in relatively inexpensive mobile devices such as mobile phones.

In a mobile device, a GPS receiver by itself may be inoperable or unfeasible due to the presence of low signal levels and/or lack of a direct view of the satellites. For example, it may be impossible to determine a location using GPS where the mobile device is being used in a building, or even in an urban area where a direct view of the satellite is masked. Additionally, the time taken for the GPS receiver to acquire the necessary satellite signals and navigation data, and calculate a position solution (called a fix)—time to first fix (TTFF)—can be as much as ten minutes or more from being switched on. This is not acceptable for services, particularly 911 emergency calls, which require a much faster acquisition time.

Assisted GPS, generally abbreviated as A-GPS, addresses the shortcomings of GPS in mobile devices. A-GPS has been widely adopted in GPS-capable mobile phones as its development was accelerated by a mandate of the U.S. Federal Communications Commission (FCC) requiring the location of a mobile phone to be available to emergency call dispatchers.

Generally, A-GPS employs a networked server having its own GPS receiver, which is located at a cellular base station (or at some other location where the receiver can “see” the GPS satellites) where the location is known and fixed. The server exchanges pertinent information with the mobile device, usually on a data channel, to determine the precise location of the device. For example, the server may supply orbital data and/or almanac of the GPS satellites to the mobile device, enabling the mobile device to lock to the satellites more rapidly. Alternatively, the server may supply accurate, surveyed coordinates of the cellular site towers to address errors affecting the GPS signal received at the mobile device. Otherwise, the mobile device may capture a snapshot of the GPS signal, with approximate time, and transmits that data to the network server to later process into a position.

One drawback of A-GPS is that it is a network dependent system. When a mobile device roams from one network, i.e., a home network, to a new network, i.e., a visiting network, A-GPS functionality may not be enabled in the new network. Roaming refers to the extension of connectivity service in a visiting network that is different from the home network where the service was registered. Although different mobile network operators have roaming agreements with each other, not all of the features are functional in the mobile device when the mobile device is roaming in a visiting network. For example, a mobile device that is activated on a United States mobile network implementing code division multiple access (CDMA) may roam into another CDMA network in Canada, but it may have limited capabilities. The mobile device may accept and receive telephone calls and short message service (SMS) messages while in Canada, but A-GPS features may not work. This may be due to different ways in which A-GPS is implemented in each network. Alternatively, A-GPS may not be serviceable in the new network due to the user failing to opt into the “international carrier” when the device was initially activated. In either case, the mobile device is unable to determine its current location and the user is deprived of location based services.

### SUMMARY OF THE INVENTION

The present invention overcomes these and other deficiencies of the prior art by providing a mobile device that is able to implement A-GPS across multiple disparate communications networks. The A-GPS technique disclosed herein implements a plurality of mobile network profiles—each profile being associated with a different mobile network and operator. For example, the mobile device may implement two mobile network profiles: a first profile associated with a first mobile network operator, e.g., Verizon, and a second profile associated with a second mobile network operator, e.g., Bell Canada. Each profile is associated with one mobile network operator, i.e., a different mobile network. Each profile comprises the necessary data identifiers to facilitate A-GPS. As soon as the mobile device detects that no signals can be received by the current active mobile network operator, it will scan its profile list and check if it can receive signals from one of the other available mobile networks signals, and if so it will use the new profile and login into the new mobile network. In addition, each profile may use a different local mobile number, e.g., a first profile is associated with a U.S. mobile number, whereas a second profile is associated with a Canadian mobile number.

In an embodiment of the invention, a mobile communications device comprises: a plurality of mobile profiles, each mobile profile corresponding to a different mobile communications network, a software application for selecting and activating one of the plurality of mobile profiles when the mobile communications device enters a service area of a mobile communications network corresponding to the selected and activated mobile profile. The mobile communications device further comprises a memory for storing a portion of the selected and activated mobile profile. The software application may comprise a Binary Runtime Environment for Wireless (BREW) application. The software application further determines a physical address and a bit length within the memory where a mobile profile is stored by the manufacturer of the mobile communications device. The mobile communications device may further comprise a GPS receiver for performing A-GPS using the mobile communications network corresponding to the selected and activated mobile profile.

In another embodiment of the invention, a method implemented in a mobile communications device comprises the steps of: identifying a mobile communications network upon entry of the mobile communications device into a service area of the mobile communications network, and activating a mobile profile corresponding to the identified mobile communications network. The method may further comprise the steps of: storing a plurality of mobile profiles, each of the plurality of mobile profiles corresponding to a different mobile communications network, and selecting from the plurality of mobile profiles a mobile profile corresponding to the identified mobile communications network. The step of activating comprises the steps of: determining a physical address within memory where a mobile profile is stored by the manufacturer of the mobile communications device, and copying the mobile profile corresponding to the identified mobile communications network to the determined physical address. The method may also comprise the step of downloading from a remote server the mobile profile corresponding to the identified mobile communications network and transmitting an identity of the mobile profile corresponding to the identified mobile communications network to a remote server. The method further comprises the step of facilitating A-GPS using the identified mobile communications network.

In another embodiment of the invention, a computer server comprises: memory for storing a plurality of mobile profiles, each of the plurality of mobile profiles corresponding to a different mobile communications network, and a communications transceiver for transmitting one or more of the plurality of mobile profiles to a mobile communications device. The communications transceiver is capable of implementing TCP/IP communications. The computer server may further comprise memory for storing a location of the mobile communications device.

An advantage of the present invention is that the mobile device will not be encumbered by the limited roaming features of the visiting network, but will instead use a different profile (e.g., mobile number) for other mobile networks to enable full functionality including A-GPS and other services such as voice and data services, short messaging service (SMS), and multimedia messaging service (MMS), and to avoid traditional roaming charges. For example, if the mobile device is currently using a profile for a Verizon mobile network in the United States, it may load and use a different profile when the mobile device enters Canada and detects a Bell Canada mobile network.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows:

FIG. 1 illustrates a mobile communications network according to an embodiment of the invention;

FIG. 2 illustrates a profile data list for a mobile device according to an embodiment of the invention; and

FIG. 3 illustrates a two country mobile network system according to an exemplary embodiment of the invention.

### DETAILED DESCRIPTION OF EMBODIMENTS

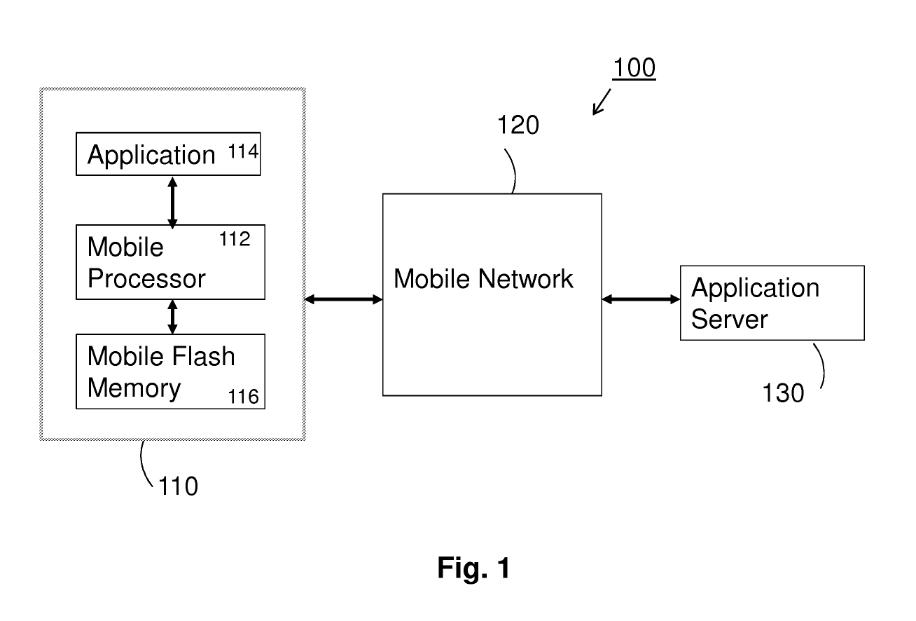

Further features and advantages of the invention, as well as the structure and operation of various embodiments of the invention, are described in detail below with reference to the accompanying FIGS. 1-3, wherein like reference numerals refer to like elements. Although the invention is described in the context of a CDMA based network and A-GPS for location determination, one of ordinary skill in the art readily appreciates that the present invention can be implemented in other types of networks, e.g., a global system for mobile communications (GSM) network, and employ other network assisted location determination techniques. Moreover, the present invention is capable of facilitating other services besides A-GPS on disparate communications networks. For example, the present invention may be used on a visiting network to facilitate other services such as, but not limited to voice and data services, short messaging service (SMS), and multimedia messaging service (MMS), and to avoid traditional roaming charges.

The present invention implements a plurality of mobile network profiles in a single mobile communications device—each profile being associated with a different mobile network and its respective carrier, i.e., operator or service provider. Ordinary, only one mobile profile is present on a mobile communications device, i.e., the mobile profile associated with the telecommunications operator of the home network. In the present invention, each profile comprises multiple data parameters that are used to authenticate a valid mobile device to the respective communications network carrier and for opening a data channel such as a transmission control protocol and internet protocol (TCP/IP) data connection. These data parameters are used to facilitate communications with a remote server on the network such as a server for performing A-GPS. As soon as the mobile device detects that no signals can be received by the current active mobile network operator, e.g., Verizon, it will assess other stored mobile profiles and determine if it can receive signals from one of the other available mobile networks signals being received, e.g., Bell Canada, and if so it will load a new mobile profile to authenticate the device for use with the visiting mobile network.

FIG. 1 illustrates a mobile communications network 100 according to an embodiment of the invention. The mobile communications network 100 comprises a plurality of mobile devices 110 (only one being shown), a mobile network 120, and an application server 130. The term “mobile device” is a general term and is intended to refer to any type of communications device that has mobile network communications capabilities. For example, a mobile device refers to a device such as, but not limited to a cellular phone, a smart phone, a laptop computer, a netbook computer, a personal digital assistant, a personal navigation system, a hand-held game console, a media recorder and/or player, and a pager. One of ordinary skill in the art appreciates that these types of devices may overlap in functionality and are not intended to be mutually exclusive. The term “mobile network” refers to any type of wireless communications network including, but not limited to cellular networks such as CDMA, GSM, Personal Communications System (PCS), General Packet Radio Service (GPRS), Evolution Data-Optimized (EV-DO), W-CDMA, and CDMA2000 based networks; and computer networks based on, for example, IEEE 802.11 or WiMAX protocols.

Each mobile device 110 comprises a processor 112, a software application 114, and a memory 116. The processor 112 handles the processing of network communications, e.g., CDMA communications, and data transfer to and from the memory 116 and software application 114. One of ordinary skill in the art readily appreciates that the mobile device 110 includes additional hardware and/or software not shown. For example, the mobile device necessary includes an appropriate communications transceiver to communicate according to the communications standard adopted in the mobile network 120 as well as location determination hardware such as a GPS chipset. Other components such as a keyboard, a display, and other circuitry and software may be included depending on the functionality employed in the mobile device 110.

The memory 116 may take any form of data storage. However, in a preferred embodiment the memory 116 comprises non-volatile computer storage such as flash memory that can be electrically erased and reprogrammed, and no power is needed to maintain the information stored therein. In a GSM system, the memory 116 may be part of a subscriber identity module (SIM) card, which is effectively a flash memory. The memory 116 may store a plurality of mobile network profiles, only one of which is active—the mobile network profiles are described in detail below. The mobile device 110 may include other memory as well, the identification and implementation of which is apparent to one of ordinary skill in the art.

The software application 114 comprises executable instructions for facilitating the determination of the location of the mobile device 110 by implementing, for example, A-GPS. The software application 114 instructs the processor 112 to communicate with the application server 130 through the mobile network 120. In an embodiment of the invention, the software application 114 supplies the application server 130 with the current location of the mobile device 110 for location based services. For example, the mobile device 110 transmits its location at predetermined intervals to the application server 130. The application server 130 stores one or more mobile network profiles, which may be download to the mobile device 110. The software application 114 in the mobile device 110 will load an active mobile profile into the memory 116 through the mobile processor 112. The mobile profile stored in the memory 116 enables the mobile device 110 to be authenticated to the mobile network 120.

In an embodiment of the invention, the application 114 is based on a standard application development platform such as the Binary Runtime Environment for Wireless (BREW) created by Qualcomm Incorporated (“Qualcomm”) Due to the prevalence of Qualcomm devices and chipsets implemented in mobile phones—developers can easily port their applications between these devices and chips using BREW. BREW, the implementation of which is apparent to one of ordinary skill in the art, provides an application program interface (API) to act between the application and the wireless mobile device on-chip operating system in order to allow programmers to develop applications without needing to code for the specific operating system of the device or understand wireless applications. The BREW platform is air-interface-independent, meaning that devices using other wireless technologies can be BREW-enabled.

However, since BREW does not offer an API function to directly write a mobile profile to the memory 114 where the active mobile network profile is stored, the application 114 instead addresses a routine of the processor 112, in order to read and write the mobile profiles to the memory 114. For example, the application 114 determines the physical address of where the active mobile profile begins in the memory 116—this physical address typically varies among different manufacturers of the mobile device 110. The application 114 also determines the bit length of the active mobile profile. By knowing both the physical address of where the active mobile profile begins and the length of the active mobile profile, the application 114 is able to write, i.e., copy, a new mobile network profile for a different mobile operator into the memory 116. As explained further below, some data elements of the mobile network profile, e.g., username and password, are not copied into the memory 116, but stay inside the BREW application 114, i.e., the BREW application layer.

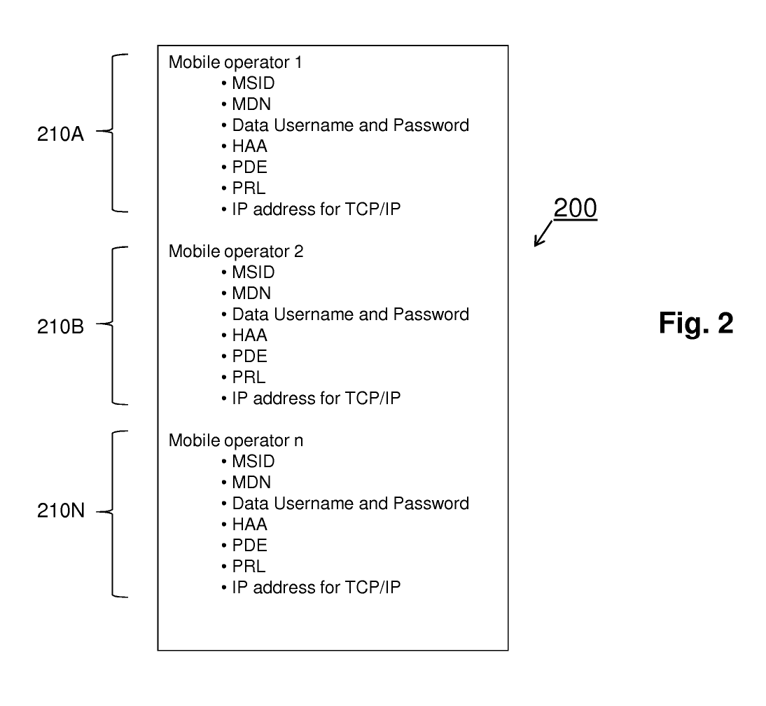

FIG. 2 illustrates a profile data list 200 for the mobile device 110 according to an embodiment of the invention. Particularly, the profile data list 200 comprises multiple mobile network profiles 210A-210N, where N is a positive integer. Each mobile network profile 210 is associated with a different mobile operator, i.e., carrier. Each profile 210 comprises a number of data elements common to each disparate mobile network for authenticating the device 110 to a visiting network and also for use in facilitating services, such as A-GPS and location based services. For example, in a mobile device 110 implementing a technique for determining location such as A-GPS, each profile 210A comprises the following exemplary data elements, the implementation of which is apparent to one of ordinary skill in the art: a mobile station identification number (MSID); a mobile directory number (MDN), which is the actual number one would dial to reach a specific mobile phone; a preferred roaming list (PRL) of frequency bands the mobile device 110 can use; a data username and password, which is used to authenticate the mobile device 110 in a mobile network 120; a home authentication agent (HAA) identifier, which comprises an internet protocol (IP) address corresponding to a primary HAA and optionally another IP address corresponding to a secondary HAA; a position determining equipment (PDE) identifier; and an IP address for the application server 130. One of ordinary skill in the art also appreciates that more or less data elements may be used depending on the nature of the mobile network 120.

In a conventional roaming scenario, the mobile device 110 would only use one profile, for example, profile 210A. In other words, when roaming in a visiting network in another country or region of coverage, the mobile device 110 uses the roaming capabilities of the visiting network, which is included in the PRL list provided by the home mobile network operator. However, according to at least one embodiment of the present invention, the mobile device 110 does not use the PRL list when in a different country or region of coverage; instead, as soon as it detects it may use a roaming partner, the software application 130 loads the appropriate profile, for example, profile 210B, which is associated with the visiting mobile network.

The profile data list 200 comprises two or more profiles 210A-N and may be stored in the software application 116. In an alternative embodiment of the invention, the profile data list 200 may be updated at any time by the application server 130. In yet another embodiment, the profile data list 200 may be updated by adding the profile 210N for a new mobile network over the air (OTA).

According to an embodiment of the invention, switching between appropriate mobile profiles occurs when the mobile device 110 fails to receive a signal from a current mobile network for a predetermined period of time. In other words, the loading of a new active mobile profile is triggered when the mobile device 110 loses the signal of the home network and “sees” a signal of a visiting network. To determine what exact profile 210A-N is to be loaded for the new visiting network 120, the software application 116 in the mobile device 110 can either select: (i) the next profile in the list 200, (ii) a random profile in the list 200, or a profile based on the last known location of the mobile device, which means that if the device 110 is close to, for example, Mexico, the application 116 will select a profile associated with a Mexico mobile network and not a profile associated with a Canada mobile network. If a new mobile profile 210A-N that is loaded does not work, the next profile in the list 200 is loaded until successful. Once a new profile 210A-N is selected and loaded, the mobile device 110 is restarted to facilitate service with the new mobile network 120. After restart, the mobile device 110 will be authenticated on the new network as a local terminal (e.g., with a Canadian number) and perform the services available, e.g., A-GPS, on the new network.

In another embodiment of the invention, the software application 116 includes an algorithm for deciding which particular profile 210A-N to use in an area where there is coverage for more than one of the profiles 210A-N stored in the device 110. For example, the algorithm is able to select which network profile 210A-N to load when the device 110 is located in regions of multi-network coverage. The algorithm can be “implicit”—for example, the algorithm always tries to use the original network until the signal strength from a new network is stronger than the original network or reaches a predetermined level. Alternatively, the algorithm can be “explicit” where the old network commands the device 110 to switch to a new network.

A mobile profile 210A is typically first loaded into the memory by a manufacturer. For example, if the mobile device 110 is provided by a manufacturer on behalf of Verizon then the manufacturer loads a profile suitable for Verizon's network into the mobile device 110. In an embodiment of the invention, the mobile device 110 is set not to roam in order for it to switch into a new active mobile profile. This will make the device 110 search the PRL when it is out of coverage and the application 114 will switch to a new appropriate mobile profile.

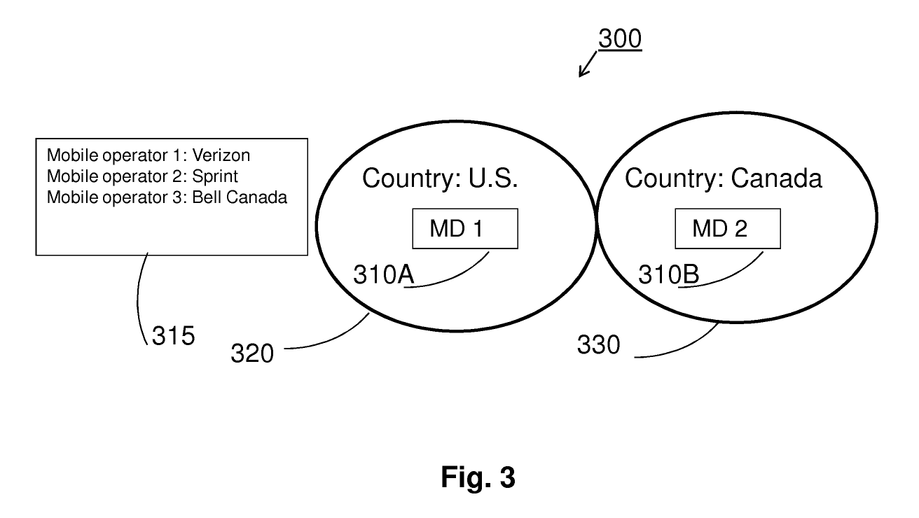

FIG. 3 illustrates a two country mobile network system 300 according to an exemplary embodiment of the invention. The mobile device system 300 comprises a first mobile device 310A, a second mobile device 310B, each having the same profile list 315. In this example, the profile list 315 includes two mobile networks in the U.S., and one mobile network in Canada. As shown, the first mobile device 310A is located within the U.S. as represented by oval 320. The second mobile device 310B is located within Canada as represented by oval 330. Since the first mobile device 310A is located within the U.S., it may use one of the two U.S. profiles stored in the list 315, i.e., Verizon or Sprint. Whereas, the second mobile device 310B uses the Canadian profile stored in the list, i.e., Bell Canada, since that device is located in Canada.

In another embodiment of the invention, the processor 112 comprises an application-specific integrated circuit (ASIC) or the like, and is loaded with the multiple profiles 210A-N. In this case, the processor 112 incorporates the functionality of the software application 116 and will select which particular profile 210A-N should be active.

According to another embodiment of the invention, the application server 130 can handle all mobile profiles 210AN and download the necessary mobile profiles to connected mobile devices 110. Each mobile profile 210A-N is activated by its mobile operator. In yet another embodiment of the invention, the application server 130 holds less mobile profiles 210A-N as mobile devices. For example, if there are 100 mobile devices in the network 120, the application server 130 holds only 50 mobile profiles. The application server 130 may download these mobile profiles only to mobiles which are entitled to use multiple mobile profiles and/or to mobile units which are close to a border to another country or region of coverage.

For example, if 20 mobile users are close to the Canadian border, the application server 130 will download a Canadian mobile profile only to those 20 units whereas the other 60 mobile units that are not close to a border will only have one mobile profile at that time. Another 20 mobile units that are close to the Mexican border will get a Mexican mobile id. This handling of mobile profiles is called “pooling”, where the number of mobile units outnumbers the number of mobile profiles.

In the case where a mobile device has currently two mobile profiles (e.g., US and Mexico) and the mobile unit returns to U.S. and is far enough from the Mexican border, the Mexican mobile profile will be deleted in that mobile unit, so other mobile units can use this Mexican mobile profile.

As noted, each mobile profile is associated with a different communications network service provider, i.e., mobile network operator. At this time, mobile network operators include, but are not limited to Verizon Wireless, T-Mobile, China Mobile, Vodafone, Telefonica, America Movil, Orange, Telenor, TeliaSonera, China Unicom, Bharti Airtel, Orascom Telecom, MTN Group, MTS, Etisalat, Reliance Communications, AT&T Mobility, Telkomsel, Telecom Italia, Zain, VimpelCom, Axiata Group Berhad, NTT docomo, BSNL, Idea Cellular, Qtel, Tata Teleservices, MegaFon, Sprint Nextel, China Telecom, and Bell Canada. One of ordinary skill in the art recognizes that a number of these operators may be affiliated with one another, may be referred to under different names in different regions, may merge with one another or cease to operate in the future, and that new operators may enter the telecommunications market as time progresses.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

We claim:

1. A mobile communications device comprising:
a plurality of mobile profiles, each mobile profile corresponding to a different mobile communications network,
a software application for selecting and activating one of the plurality of mobile profiles when the mobile communications device enters a service area of a mobile communications network corresponding to the selected and activated mobile profile.

2. The mobile communications device of claim 1, further comprising a memory for storing a portion of the selected and activated mobile profile.

3. The mobile communications device of claim 1, wherein the software application comprises a Binary Runtime Environment for Wireless (BREW) application.

4. The mobile communications device of claim 1, wherein the software application further determines a physical address within the memory where a mobile profile is stored by the manufacturer of the mobile communications device.

5. The mobile communications device of claim 4, wherein the software application further determines a bit length of the mobile profile stored by the manufacturer of the mobile communications device.

6. The mobile communications device of claim 1, further comprising a GPS receiver for performing A-GPS using the mobile communications network corresponding to the selected and activated mobile profile.

7. A method implemented in a mobile communications device, the method comprising the steps of:
identifying a mobile communications network upon entry of the mobile communications device into a service area of the mobile communications network, and
activating a mobile profile corresponding to the identified mobile communications network.

8. The method of claim 7, further comprising the steps of:
storing a plurality of mobile profiles, each of the plurality of mobile profiles corresponding to a different mobile communications network, and
selecting from the plurality of mobile profiles a mobile profile corresponding to the identified mobile communications network.

9. The method of claim 7, wherein the step of activating comprises the steps of:
determining a physical address within memory where a mobile profile is stored by the manufacturer of the mobile communications device, and
copying the mobile profile corresponding to the identified mobile communications network to the determined physical address.

10. The method of claim 6, further comprising the step of downloading from a remote server the mobile profile corresponding to the identified mobile communications network.

11. The method of claim 6, transmitting an identity of the mobile profile corresponding to the identified mobile communications network to a remote server.

12. The method of claim 6, further comprising the step of facilitating A-GPS using the identified mobile communications network.

13. A computer server comprising:
memory for storing a plurality of mobile profiles, each of the plurality of mobile profiles corresponding to a different mobile communications network, and
a communications transceiver for transmitting one or more of the plurality of mobile profiles to a mobile communications device.

14. The computer server of claim 13, wherein the communications transceiver is capable of implementing TCP/IP communications.

15. The computer server of claim 13, further comprising memory for storing a location of the mobile communications device.
